(19) United States
(12) Patent Application Publication
(10) Pub. No.: US 2007/0257455 A1
(43) Pub. Date: Nov. 8, 2007

(54) Toolbox with baggage space

(76) Inventor: Yao-Lin Cho, Taichung City (TW)

Correspondence Address: Yao-Lin Cho, 235 Chung-Ho, Box 8-24 Taipei, Taipei, TW

(21) Appl. No.: 11/416,425

(22) Filed: May 3, 2006

(51) Int. Cl. B62B 1/00

(52) U.S. Cl. 280/47.26

(57) ABSTRACT

A toolbox with a baggage space comprises a toolbox body having an openable cover; one side of the cover being pivotally installed to the toolbox body and another side thereof having at least one buckle; a back side of the toolbox body having a pull rod; a lower side of the toolbox body having two wheels; by the pull rod and wheels, the toolbox can be pulled easily; an interior of the toolbox body having a baggage space; the baggage space having an opening; a periphery of the opening of the baggage space having a rib portion for assembling a movable plate; the movable plate serving to seal the baggage space; and an inner side of the cover and an upper side of the movable plate being installed with a plurality of receiving grooves for receiving tools.

### FIELD OF THE INVENTION

The present invention relates to toolboxes, and particularly to a toolbox with a baggage space, wherein the toolbox has at least one groove for receiving tools and a baggage space for receiving non-tool object so that the user can place the objects and tools in the toolbox. Thus user can carry the objects and tools easily and comfortably.

### BACKGROUND OF THE INVENTION

Toolbox is a box with a plurality of grooves for receiving various tools, such as a socket, a spanner, an opener head, a handle, an inner hexagonal spanner, etc. Furthermore, in one development, the toolbox is added with a pull rod and wheel so that the toolbox body can be pulled to move easily.

However in many situation, the workers must carry tools and other objects, such a working clothes, bags, etc. in working. However the prior art toolbox do not provide such kind of space for receiving these objects. Generally, the grooves in the toolbox are narrow and small and thus they are not suitable for receiving such objects. Therefore, workers must carry these objects additionally. It is inconvenient. Furthermore, they are easily lost or the workers forget to carry some of the objects.

### SUMMARY OF THE INVENTION

Accordingly, the primary object of the present invention is to provide a toolbox with a baggage space, wherein the toolbox has at least one groove for receiving tools and a baggage space for receiving non-tool object so that the user can place the objects and tools in the toolbox. Thus users can carry the objects and tools easily and comfortably.

To achieve above objects, the present invention provides a toolbox with a baggage space which comprises a toolbox body having an openable cover; one side of the cover being pivotally installed to the toolbox body and another side thereof has at least one buckle; a back side of the toolbox body having a pull rod; a lower side of the toolbox body having two wheels; by the pull rod and wheels, the toolbox can be pulled easily; an interior of the toolbox body has a baggage space; the baggage space having an opening; a periphery of the opening of the baggage space having rib portion for assembling a movable plate; the movable plate serves to seal the baggage space; and an inner side of the cover and an upper side of the movable plate are installed with a plurality of receiving grooves for receiving tools.

The various objects and advantages of the present invention will be more readily understood from the following detailed description when read in conjunction with the appended drawing.

### BRIEF DESCRIPTION OF THE DRAWINGS

FIG. 1 is a perspective view of the toolbox with a baggage space according to the present invention.

FIGS. 2 and 3 are schematic perspective view of the toolbox with a baggage space of the present invention.

FIG. 4 is a schematic view showing that the cover of the toolbox body of the present invention is covered.

FIG. 5 is a schematic perspective view of the toolbox with a baggage space of the present invention, wherein the present invention is at a state to be carried.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

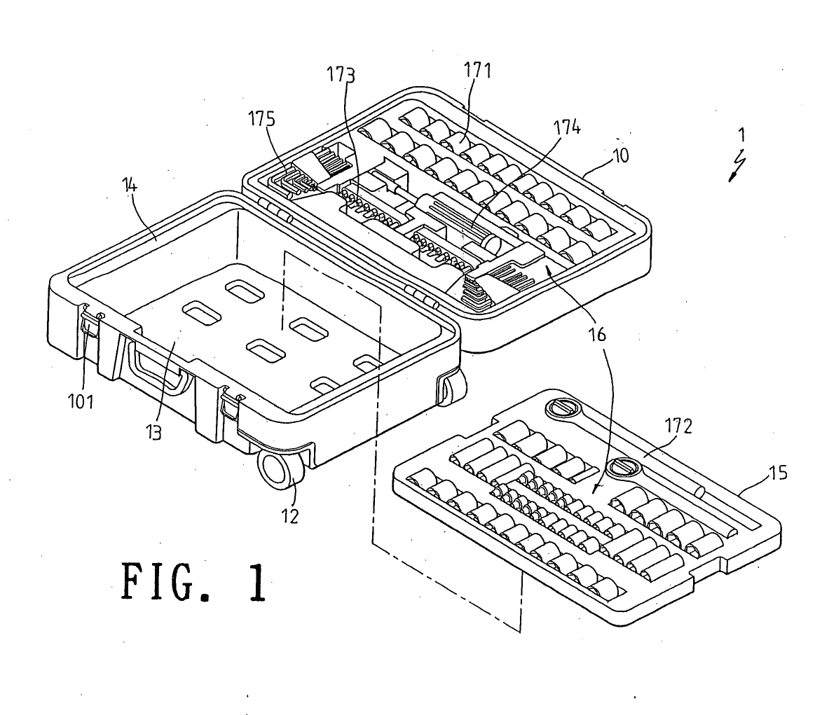

Referring to FIG. 1, a toolbox with a baggage space is illustrated. The present invention has the following structure.

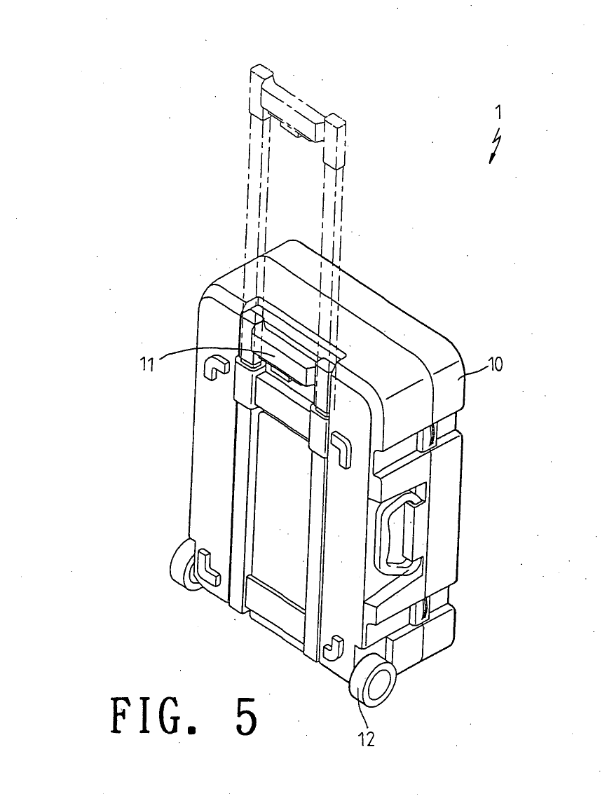

A toolbox body 1 has an openable cover 10. One side of the cover 10 is pivotally installed to the toolbox body 1 and another side thereof has at least one buckle 101. In this embodiment two buckles 101 are illustrated. A backside of the toolbox body 1 has a pull rod 11 (referring to FIG. 5). A lower side of the toolbox body 1 has two wheels 12. By the pull rod 11 and wheels 12, the toolbox can be pulled easily.

An interior of the toolbox body 1 has a baggage space 13. The baggage space 13 is at a lower space of the toolbox body 1. The baggage space 13 has an opening. A periphery of the opening of the baggage space 13 has a rib portion 14 for assembling a movable plate 15. The movable plate 15 serves to seal the baggage space 13.

An inner side of the cover 10 and an upper side of the movable plate 15 are installed with a plurality of receiving grooves 16 for receiving various tools, such as a socket 171, a spanner 172, an opener head 173, a handle 174, an inner hexagonal spanner 175, etc.

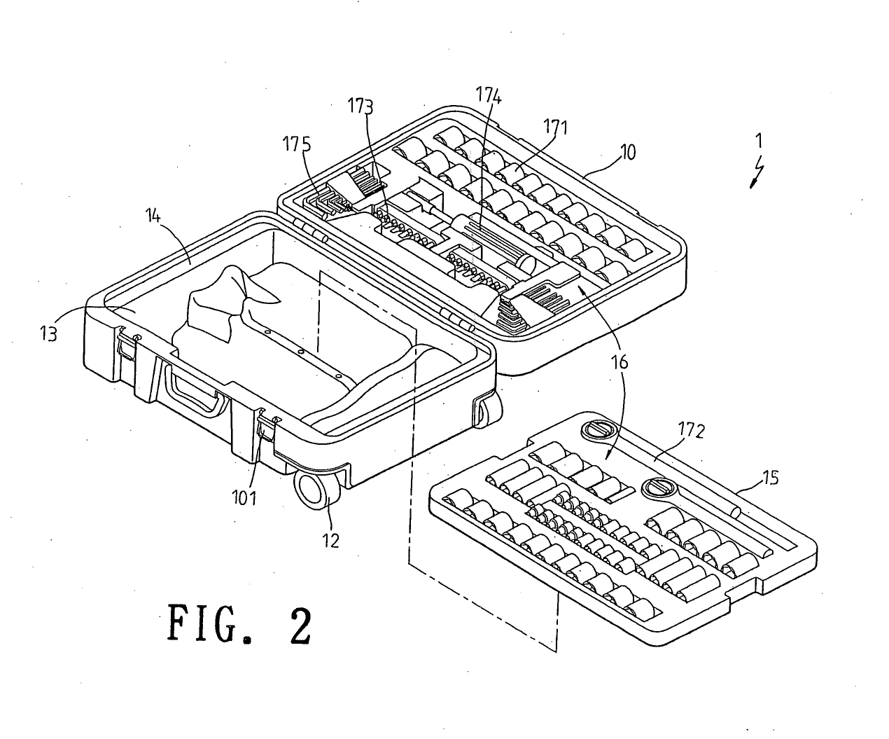

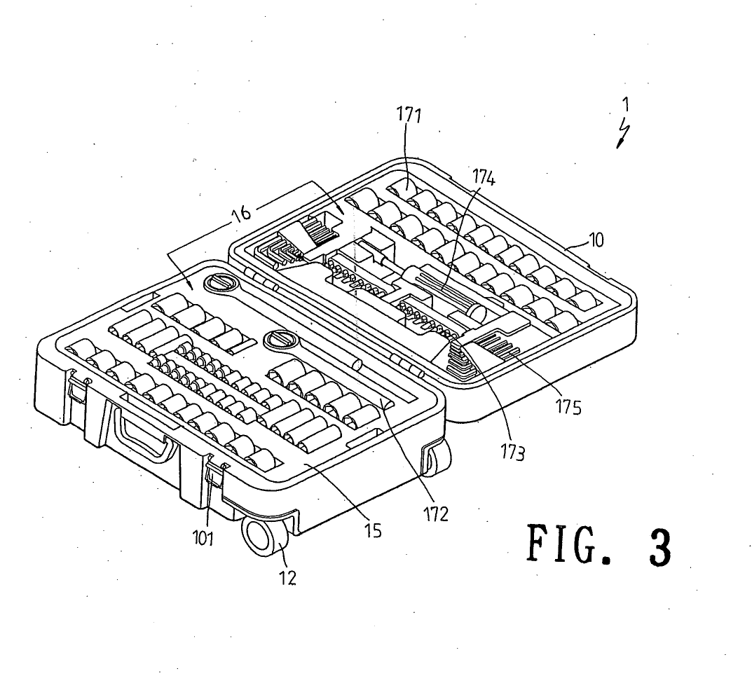

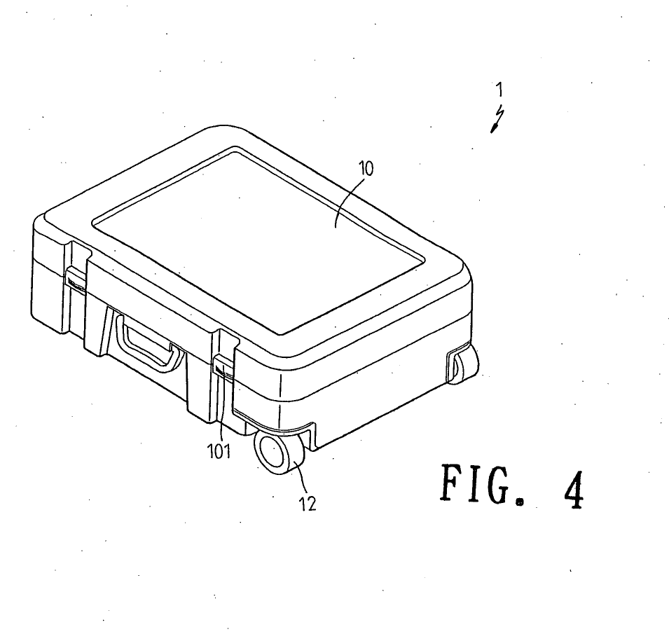

Referring to FIGS. 2 to 5, in use of the present invention, the baggage space 13 serves for placing non-tool objects, such as clothes or bags, or other fittings. The movable plate 15 serves to seal the baggage space 13 so that the baggage space 13 will not be polluted by dirt, sands, etc. The movable plate 15 is buckled to the rib portion 14 of the baggage space 13. Then the cover 10 seals the opening of the toolbox body 1.

In carrying, the pull rod 11 can be pulled out from the toolbox body 1, as shown in FIG. 5. The user pulls one end of the pull rod 11. The wheels 12 at the bottom of the toolbox body 1 can drive the toolbox body 1 to move so that the user can pull the toolbox body 1 easily and comfortably.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A toolbox with a baggage space comprising:
a toolbox body; a backside of the toolbox body having a pull rod; a lower side of the toolbox body having wheels; by the pull rod and wheels, the toolbox can be pulled easily;
an interior of the toolbox body having a baggage space; the baggage space having an opening; and
an inner side of the cover and an upper side of the movable plate being installed with a plurality of receiving grooves for receiving tools.

2. The toolbox with a baggage space as claimed in claim 1, wherein the pull rod is telescopic.

3. The toolbox with a baggage space as claimed in claim 1, wherein a periphery of the opening of the baggage space has a rib portion for assembling a movable plate; the movable plate serves to seal the baggage space.

4. The toolbox with a baggage space as claimed in claim 1, wherein a toolbox body having an openable cover; one side of the cover being pivotally installed to the toolbox body and another side thereof has at least one buckle.

5. A toolbox with a baggage space comprising:
a toolbox body having an openable cover; one side of the cover being pivotally installed to the toolbox body and another side thereof having at least one buckle; a backside of the toolbox body having a pull rod; a lower side of the toolbox body having two wheels; by the pull rod and wheels, the toolbox can be pulled easily;
an interior of the toolbox body having a baggage space; the baggage space having an opening; a periphery of the opening of the baggage space having rib portion for assembling a movable plate; the movable plate serving to seal the baggage space; and
an inner side of the cover and an upper side of the movable plate being installed with a plurality of receiving grooves for receiving tools.
